(19) United States
(12) Patent Application Publication
(10) Pub. No.: US 2022/0030308 A1
(43) Pub. Date: Jan. 27, 2022

(54) METHOD AND DEVICE FOR STREAMING CONTENT

(71) Applicant: National University of Singapore, Singapore (SG)

(72) Inventors: Abdelhak BENTALEB, Singapore (SG); Praveen Kumar YADAV, Singapore (SG); Roger ZIMMERMAN, Singapore (SG); Wei Tsang OOI, Singapore (SG)

(21) Appl. No.: 17/296,948

(22) PCT Filed: Sep. 13, 2019
(86) PCT No.: PCT/SG19/50461

§ 371 Date: May 25, 2021

(30) Foreign Application Priority Data
Sep. 14, 2018 (SG) 10201807988R

(51) Int. Cl. H04N 21/462; H04L 29/06; H04L 12/851; H04N 21/262; H04N 21/845; H04N 21/437; H04N 21/44; H04N 21/442

(52) U.S. Cl. CPC H04N 21/4622; H04L 67/42; H04L 65/4069; H04L 47/24; H04N 21/44209; H04N 21/8456; H04N 21/437; H04N 21/44004; H04N 21/26258

(57) ABSTRACT

A method of streaming remotely located content, performed at a client device, comprises: communicating with a plurality of servers each of which hosts multiple copies of the content, said copies being encoded at different respective bitrates and each being divided into a plurality of segments that are arranged according to a time sequence; and requesting a concurrent download of a set of segments from a group of download servers that is at least a subset of the plurality of servers; wherein respective segments in the set are downloaded from different servers in the group of download servers, said segments being consecutive in the time sequence.

### TECHNICAL FIELD

The present disclosure relates to methods and devices for streaming content.

### BACKGROUND

The increased availability of high-speed and high-bandwidth Internet connections has seen streaming services become almost ubiquitous in recent times. For example, HTTP Adaptive Streaming (HAS) is used by many such streaming services due to its ability to deliver high quality streams via conventional HTTP servers. It is thought that HAS systems will dominate Internet traffic by 2021.

The increase in video network traffic creates challenges for maintaining quality of user experience. One proposed method for addressing this is implemented in the Dynamic Adaptive Streaming over HTTP (DASH) framework. With DASH, a client typically accesses one server at a time and only redirects to another server via DNS redirect if a network bottleneck develops. The available media bitrate levels and resolutions are discrete. The clients that share an overloaded server or a bottleneck link limit themselves to low bitrate levels to avoid playback stalls. Conversely, clients that happen to be able to access less loaded servers can achieve a much higher video quality, so that the Quality-of-Experience (QoE) can vary widely from client to client.

DASH adapts dynamically to the network conditions thanks to its Adaptive BitRate (ABR) scheme that is based on heuristics like throughput measurements, playback buffer occupancy, or a combination of both. Furthermore, because it uses HTTP, it enables content providers to use existing content delivery network (CDN) infrastructure and simplifies the traversal through network middleboxes. Finally, it is highly scalable, and DASH clients can request and fetch video segments independently maintaining their local playback state in a decentralized way using stateless DASH servers.

A DASH system includes two main entities: a DASH server and a DASH client. The DASH server stores videos that are divided into small fixed segments (2-15 seconds) and each segment is encoded at various bitrate levels and resolutions. The segments of each video are then listed in a Media Presentation Description (MPD), which also includes metadata information of segment durations, codec/encryption details, and track correspondences (audio and subtitles). After an authentication phase, the client first fetches the MPD file of the video to be viewed, and then requests the segments sequentially based on its ABR controller decisions. The DASH server responds by sending the requested segments through HTTP. The ABR controller implements various heuristics to decide the bitrate to select for the next segments. Thus, it switches between available bitrates in case of network throughput variations and buffer occupancy changes.

In a DASH delivery system, every DASH client strives to improve its QoE by making the best bitrate decision that can accommodate the underlying network conditions without introducing stalls. The bitrate decision is performed using an ABR logic which relies on throughput estimations and buffer occupancy measurements. However, selecting the right decision in existing network infrastructures using DASH is difficult for at least two reasons:
Lack of bandwidth: The increasing amount of DASH traffic and the ever-growing user demands for higher video quality have led to an explosive consumption of bandwidth. In standard DASH, achieving a high QoE over existing bandwidth-limited networks is very challenging because of frequent congestion. Congestion occurs due to DASH clients competing for the available bandwidth. This competition causes video instability, stalls, long startup delays, and many changes in the quality, and thus significantly impacts the user experience. The high traffic load for video content is often shared between CDNs based on some redirection policy (CDN-based load balancing rules). In such a system, a DASH client uses only one node at a time and gets connected to a new node if a bottleneck is detected based on the policy decided by the content provider. The clients connected to more overloaded nodes get a lower share of throughput, leading to unfairness.
Server-side bottlenecks: In standard DASH solutions, typically only one server is considered for sequential segment delivery determined by a given base URL (i.e., the next segments can be downloaded only if the current one is fully downloaded). This one segment at time mechanism represents a weak spot in the presence of a bottleneck on the server-side. The problem is exacerbated if the minimum bitrate of the encoded segments is higher than the throughput of the bottleneck link. The server bottleneck issue results in increasing stalls, video instability, frequent changes in bitrate, and unfairness. Previously proposed systems seek to identify the bottleneck using a simple network metric (e.g., latency, download time, throughput), and then select the appropriate server based on the network metric. However, these proposals are: (i) not adaptable to existing DASH delivery systems or (ii) need modifications on the network-side, or (iii) are not scalable (i.e., each client needs to report its state to the network controller).

The above-mentioned factors negatively affect the viewer QoE for DASH even in the presence of CDN-based redirection policies, and the problems are exacerbated in the presence of a bottleneck.

Client requests made to servers can be sequential-based or parallel-based.

In a sequential-based approach, the scheduler requests the video segments on a sequential basis one after the other, and the next segment cannot be downloaded until the requested one is fully downloaded. The ABR controller of the client may use a rate-based, buffer-based, or mixed-based heuristic for scheduling purposes.

In a parallel-based approach, the scheduler requests and downloads multiple segments in parallel from different video servers at the same time. In most cases this requires a kernel or network functionality modification in both the application layer and the transport layer. For example, some proposals include making use of multiple network interfaces employed in the client (e.g., WiFi and cellular) and the MPTCP protocol to download from different access networks. Another parallel-based implementation has been proposed by Queyreix et al. (IEEE CCNC, pages 580-581, 2017) and known by the name MS-Stream (Multiple-Source Streaming over HTTP). MS-Stream is a pragmatic evolving HAS based streaming solution for DASH that uses multiple customized servers to improve the end-user QoE. Although MS-Stream shows good performance in delivering high quality videos, the proposed solution has some limitations: (i) it uses Multiple Description Coding (MDC) for encoding video, which is not a standard now; (ii) the implementation needs a specific API at each server which is not in accordance with the DASH standard; (iii) there is a time overhead to combine the content before playing, which might not be acceptable for standard QoS and QoE; (iv) existing DASH storage servers and CDN architecture on the Internet require modification that might be significant; and (v) all the content downloaded is not playable, and there is significant overhead, such that the aggregate throughput from multiple servers is not fully utilized.

Embodiments of the present disclosure seek to overcome or alleviate one or more of the above difficulties, or at least to provide a useful alternative.

### SUMMARY

The present disclosure provides a method, performed at a client device, of streaming remotely located content, comprising:
communicating with a plurality of servers each of which hosts multiple copies of the content, said copies being encoded at different respective bitrates and each being divided into a plurality of segments that are arranged according to a time sequence; and
requesting a concurrent download of a set of segments from a group of download servers that is at least a subset of the plurality of servers,
wherein respective segments in the set are downloaded from different servers in the group of download servers, said segments being consecutive in the time sequence.

The method may further comprise monitoring a playback buffer occupancy of the client device. In certain embodiments, the method comprises selecting a bitrate at which to download segments, based on the playback buffer occupancy of the client device and/or estimated throughput of the group of download servers.

The method may comprise identifying one or more bottleneck servers of the plurality of servers; and temporarily removing the one or more bottleneck servers from the group of download servers. Some embodiments may further comprise monitoring a throughput status of the one or more bottleneck servers by requesting, from the one or more bottleneck servers, download of a segment that is already being downloaded from a server in the group of download servers. The method may comprise, responsive to the throughput status of a bottleneck server exceeding a bitrate threshold, restoring the bottleneck server to the group of download servers.

The servers may be DASH servers.

The present disclosure also provides a client device for streaming remotely located content, comprising:
at least one processor in communication with computer-readable storage having stored thereon instructions which, when executed by the at least one processor, cause the client device to:
communicate with a plurality of servers each of which hosts multiple copies of the content, said copies being encoded at different respective bitrates and each being divided into a plurality of segments that are arranged according to a time sequence; and
request a concurrent download of a set of segments from a group of download servers that is at least a subset of the plurality of servers;
wherein respective segments in the set are downloaded from different servers in the group of download servers, said segments being consecutive in the time sequence.

The instructions may further comprise instructions which, when executed by the at least one processor, cause the client device to monitor a playback buffer occupancy of the client device. The instructions may further comprise instructions which, when executed by the at least one processor, cause the client device to select a bitrate at which to download segments, based on a playback buffer occupancy of the client device and/or estimated throughput of the group of download servers.

The instructions may further comprise instructions which, when executed by the at least one processor, cause the client device to: identify one or more bottleneck servers of the plurality of servers; and temporarily remove the one or more bottleneck servers from the group of download servers.

The instructions may further comprise instructions which, when executed by the at least one processor, cause the client device to: monitor a throughput status of the one or more bottleneck servers by requesting, from the one or more bottleneck servers, download of a segment that is already being downloaded from a server in the group of download servers. The instructions may further comprise instructions which, when executed by the at least one processor, cause the client device to, responsive to the throughput status of a bottleneck server exceeding a bitrate threshold, restore the bottleneck server to the group of download servers.

The present disclosure further provides a non-volatile computer-readable storage medium having instructions stored thereon that, when executed by at least one processor of a client device, cause the client device to perform a method as disclosed herein.

The present disclosure further provides a computing device for streaming remotely located content from a plurality of servers each of which hosts multiple copies of the content, said copies being encoded at different respective bitrates and each being divided into a plurality of segments that are arranged according to a time sequence, the client device comprising:
a download scheduler that is configured to request a concurrent download of a set of segments from a group of download servers that is at least a subset of the plurality of servers,
wherein the download scheduler is configured to download respective segments in the set from different servers in the group of download servers, said segments being consecutive in the time sequence.

Embodiments may further comprise a buffer controller that is configured to monitor a playback buffer occupancy of the computing device.

Embodiments may further comprise an adaptive bitrate controller that is configured to: communicate with the buffer controller to receive the playback buffer occupancy; and select a bitrate at which to download segments, based on the playback buffer occupancy of the computing device and/or estimated throughput of the group of download servers.

Certain embodiments may comprise a throughput estimator for determining estimated throughput of the group of download servers.

The download scheduler may be configured to: identify one or more bottleneck servers of the plurality of servers; and temporarily remove the one or more bottleneck servers from the group of download servers. The download scheduler may further be configured to: monitor a throughput status of the one or more bottleneck servers by requesting, from the one or more bottleneck servers, download of a segment that is already being downloaded from a server in the group of download servers. In some embodiments, the download scheduler is configured to, responsive to the throughput status of a bottleneck server exceeding a bitrate threshold, restore the bottleneck server to the group of download servers.

### BRIEF DESCRIPTION OF THE DRAWINGS

Embodiments of the present disclosure will now be described, by way of non-limiting example only, with reference to the accompanying drawings in which:

FIG. 1 shows an overview of an example architecture of a system for streaming content;

FIG. 2 shows a detailed architecture of an embodiment of a streaming client;

FIG. 3 shows an example of a queue model for embodiments of a streaming client;

FIG. 4 schematically depicts segment scheduling with and without bottlenecks;

FIG. 5 schematically depicts scheduling policy in the case of out-of-order segment arrival;

FIG. 6 shows an example architecture of a dash.js based player;

FIG. 7 is a bar plot of the average bitrate for clients when connected to servers having different profiles (P1-P5) and when all clients share all the servers for different buffer capacity configurations (30, 60, and 120)s;

FIG. 8 is a bar plot of the average number of changes in representation when clients are connected to server with different profiles (P1-P5) and when all clients share all the servers (MSDASH) for different buffer capacity configurations (30, 60, and 120)s;

FIG. 9 shows stall duration and number of stalls when clients are connected to servers with different profiles (P1-P5) and when all clients share all the servers (MSDASH) for different buffer capacity configurations (30, 60, and 120)s;

FIG. 10 shows the average QoE when clients are connected to servers having different bandwidths (P1-P5) and when all clients share all the servers with different bandwidth (MSDASH) for different buffer capacity configurations;

FIG. 11 shows average bitrate for embodiments of the present disclosure compared with CDN-based load balancing rules;

FIG. 12 shows average number of changes in representation for embodiments of the present disclosure compared with CDN-based load balancing rules;

FIG. 13 shows average QoE for embodiments of the present disclosure compared with CDN-based load balancing rules;

FIG. 14 shows stall duration and number of stalls for embodiments of the present disclosure compared with CDN-based load balancing rules;

FIG. 15 shows average bitrate and changes in quality for 2 and 4 seconds segment duration for 5 clients starting together and with a gap of 60 s;

FIG. 16 shows bitrate fairness comparison of clients according to embodiments of the present disclosure with single server clients. (a) One MSDASH client and one single server client; (b) Two single server client sharing the same server; (c) Bitrate over time, single server DASH (left) and MSDASH (right); (d) Bitrate over time, single server client 1 (left) and client 2 (right);

FIG. 17 shows performance comparison of embodiments of the present disclosure with different segment durations for 30 seconds buffer capacity;

FIG. 18 shows average bitrate, changes in representation, and QoE of 100 clients with different total bandwidth (300, 350, and 400)Mbps and buffer capacity configurations (30, 60, and 120)s, for embodiments of the present disclosure compared to clients using CDN-based load balancing rules. (a) 100 clients sharing a bottleneck network with total bandwidth of 300 Mbps and 4 servers with fixed network profiles (60, 70, 80, and 90) Mbps; (b) 100 clients sharing a bottleneck network with total bandwidth of 350 Mbps and 4 servers with fixed network profiles (60, 70, 80, and 140) Mbps; (c) 100 clients sharing a bottleneck network with total bandwidth of 400 Mbps and 4 servers with fixed network profiles (60, 70, 80, and 190) Mbps;

FIG. 19 shows an example architecture of a client device;

FIG. 20 is a flow diagram of an example of a streaming process according to certain embodiments; and

FIG. 21 is a flow diagram of an example of a bitrate selection process.

### DETAILED DESCRIPTION

Embodiments of the present disclosure relate to a method of streaming remotely located content, and to a client device configured to execute the method. At least some embodiments may be referred to herein as MSDASH (Multi-Server DASH).

In embodiments of the present disclosure, multiple clients may share more than one server in parallel. The sharing of servers results in achieving a uniform QoE, and a bottleneck link or an overloaded server does not create a localized impact on clients. The functionality of the presently disclosed embodiments is implemented in a distributed manner in the client-side application layer, and may be a modified version of the existing DASH client-side architecture, for example. Accordingly, the presently disclosed embodiments do not require any modifications to kernel or network functionality, including transport layer modifications.

As will be described in detail below, it has been found that embodiments of the present disclosure can significantly improve streaming performance, including the following improvements:
A 33% higher QoE with less than 1% variation amongst the clients, compared to a sequential download from a single server.
High robustness against server bottlenecks and variable network conditions. The presently proposed solution does not overexploit the available bandwidth and the additional data overhead is on additional segment download of media data for 10-minutes of video playback in most cases.
Significant outperformance of sequential single-server DASH and CDN-based load balancing rules including: Round Robin, Least Connected, Session Persistence, and Weighted.

Advantageously, embodiments of the present disclosure deal with bottlenecks efficiently by first determining the bottleneck or faulty server; ceasing to request future segments from the determined bottleneck server; and monitoring the status of the bottleneck server periodically for any changes (e.g., it may become a healthy server again), for example via probe-based passive or active measurements.

In addition, the presently disclosed embodiments provide a fairer and higher QoE than prior art approaches, and reach the best bitrate by leveraging the expanded bandwidth and link diversity from multiple servers with heterogeneous capacities. Embodiments of the present disclosure provide a purely client-driven solution where the modifications are restricted to the client-side application. Thus, the network and server sides remain unchanged, making implementation less complex and less prone to error.

In the present disclosure, the following symbols and abbreviations are used.

TABLE I
List of key symbols and notations.

| Notation | Definition |
|---|---|
| T | Total video duration |
| t | Segment download step |
| C | Set of DASH clients |
| S | Set of DASH servers |
| N | Total number of clients |
| M | Total number of servers |
| B | Playback buffer occupancy |
| ρ | Queue server utilization |
| τ | Segment duration |
| λ | Arrival rate |
| μ | Queue rate |
| O | Expected average queue length |
| w | Segment download throughput |
| R | List of bitrate |
| L | List of content resolution |
| K | Queue/buffer capacity |
| Bs | Buffer slack |
| H | Total number of bottleneck servers |
| Z | Total number of segments |
| seg | A segment |
| η | Total number of encoding levels |

Embodiments of the present disclosure implement, at a client device, a bitrate selection process that is governed by a playback buffer occupancy of the client device, an estimated throughput of a group of servers from which the client device can request segments of data, or a combination of playback buffer occupancy and estimated throughput of the group of servers.

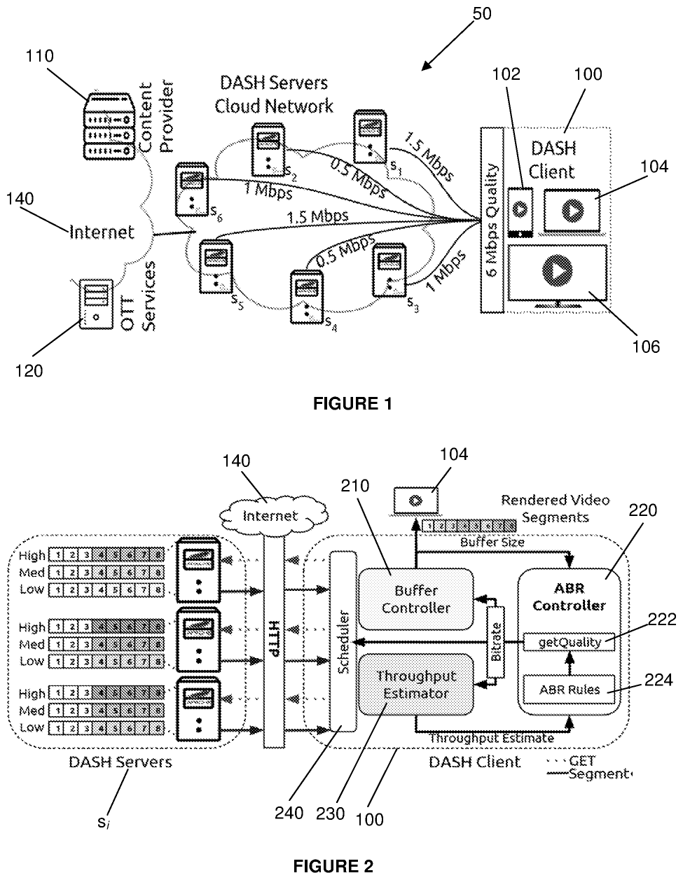

One possible architecture of a system 50 for streaming content is shown in FIG. 1. A client 100 executing on a computing device (such as a mobile device 102, laptop computer 104 or desktop computer 106) is capable of connecting to a plurality of servers via a wide area network such as the Internet 140 to request data. In the example shown in FIG. 1, the system 50 includes six servers (labelled s₁ to s₆ respectively), though fewer or more servers may be provided. In some embodiments, tens or even hundreds of servers may be deployed as part of system 50. Typically, the servers sᵢ will be DASH servers to which a client 100 can connect and request content via HTTP GET requests, and the client 100 may be implemented as a modified version of the dash.js reference player, for example.

Typically, servers sᵢ mirror data that is provided by a content provider 110, usually via an Internet 140 connection. Other parties, such as over-the-top (OTT) services 120, may also provide content to the servers sᵢ for clients 100 to stream.

A client 100 according to the presently disclosed embodiments makes parallel requests for different segments from at least a subset, and preferably all, of the available servers sᵢ to maximise the throughput of the multiple servers. For example, as shown in FIG. 1, if the available throughput from five different servers is 2 Mbps, 1 Mbps, 1.5 Mbps, 0.5 Mbps, and 1 Mbps, the client 100 should be able to play a video quality equivalent to 6 Mbps without any stalls.

Each client 100 may be arranged to request segments from multiple servers simultaneously, which may be geographically distributed. Clients 100 may leverage the link diversity in the existing network infrastructure to provide a robust video streaming solution.

Importantly, the presently disclosed embodiments can be implemented without any modifications in the DASH servers or the network. All modifications are performed at client 100, and thus no changes are required to the kernel. Client 100 may represent a video player that supports a DASH system such as the reference player dash.js.

Each client 100 is characterized by capabilities of the device 102, 104 or 106 on which it executes (such as display resolution, memory and CPU), and may request various content types (e.g., animation, movie, news, etc.). Client 100 may implement one or more adaptive bitrate (ABR) processes.

Further details of an example architecture of a client 100 are shown in FIG. 2. Client 100 may comprise the following four components.
(i) A buffer controller 210 which tracks the playback buffer occupancy. Buffer controller 210 may include logic for checking whether a bitrate selected by an ABR controller 220 leads to video stalls, and if that is the case, selecting a new suitable bitrate. Buffer controller 210 may also include logic for maintaining the bitrate at a safe level, for example, between two predefined high and low thresholds. Buffer controller 210 provides data regarding buffer size to ABR controller 220 for input to a rate adaptation algorithm, such that ABR controller 220 can select an appropriate bitrate.
(ii) A throughput estimator 230 that predicts the download throughput of a segment from a server s and provides the estimate to ABR controller 220 for input to a rate adaptation algorithm. Throughput estimator 230 may consider two kinds of smoothing function for throughput prediction, including the last three mean throughputs, or the last throughput, for example.
(iii) An ABR controller 220 that implements a rate adaptation algorithm (also referred to herein as an ABR algorithm) using one or more ABR rules 224, in conjunction with buffer size data from buffer controller 210 and/or throughput data from throughput estimator 230, to decide which bitrate should be selected for the next segment to be downloaded. For example, the ABR rules 224 may include buffer-based bitrate selection, rate-based bitrate selection, or mixed bitrate selection that combines buffer and throughput (rate-based) considerations. The ABR algorithm may select the best possible bitrate to stream content with the maximum possible quality. ABR controller 220 provides the selected bitrate to scheduler 240 for scheduling downloads, to buffer controller 210.
(iv) A scheduler 240 that controls, requests, and downloads the appropriate segment from the corresponding server. The scheduler 240 may also be responsible for avoiding the download of the same segments multiple times to save bandwidth, as well as to avoid performance degradations due to bottleneck servers.

For example, for each segment download tϵ[1, . . . , Z] where Z denotes the total number of downloading steps, the client 100 may use ABR controller 220 to choose the appropriate bitrate rᵢ which adapts to the download throughput of each source sᵢ with iϵ[1, . . . , M] and playback buffer occupancy where M represents the total number of existing servers. Then, client 100 may concurrently request (via scheduler 240) multiple successive segments from M servers s₁. When the playback buffer monitored by buffer controller 210 reaches its maximum capacity K, client 100 may trigger (via buffer controller 210) an event to stop downloading, and to decrease the number of servers gradually down to a single server, for avoidance of buffer overflow. The number of servers used may be increased until it reaches M whenever there is room to accommodate segments, i.e., when maximum buffer capacity is not reached. In some embodiments, system 50 may be modelled by representing it by a direct or undirected graph G=(V, E) where V=C∪S is the set of clients C={c₁, . . . , c_{N}} and servers S={s₁, . . . , s_{M}}. For modelling purposes, a full mesh network may be assumed, i.e., Fat-Tree topology (e.g., OSPF mesh network) where every client cⱼ ϵC with j=[1 . . . N] has connectivity to each sᵢ ϵS and i=[1 . . . M], and thus a client 100 uses diverse multiple links to fetch successive segments simultaneously from existing servers.

When the playback buffer becomes full then the client 100 stops downloading segments and decreases the total number of used servers gradually down to one. Otherwise, if there is room in the playback buffer, then the client 100 may increase the number of servers until it utilizes all existing servers (full server utilization).

Due to congestion and network variability, at any time, the link to server sᵢ may become slow and the server would then be considered to be a bottleneck server. In this situation, the client 100 suffers from stalls since the delayed segments from the bottleneck servers lead to a drain of the client playback buffer. To avoid this issue, in certain embodiments, the client 100 may stop fetching future segments from the bottleneck servers and instead fetch from only the M−H remaining servers, where His the total number of bottleneck servers. Each client 100 may keep track of the statuses of bottleneck servers by requesting previous segments with the lowest quality, and once they can provide service and satisfy client requirements again, resume use of the bottleneck servers.

In certain embodiments, before starting a streaming session (i.e., either live or on demand) and after an authentication process, every client 100 may first fetch an MPD file (typically, an XML file that includes a description of the resources forming a streaming service), and then the video segments in parallel from the existing DASH servers. The segments of each video v are stored in the set of DASH servers S, each video of T seconds is divided into a Z (=T/τ) segments, and each segment segₜ where tϵ[1 . . . Z] has a fixed duration τ seconds and is encoded at various bitrate levels Rᵥ and resolutions Lᵥ denoted η.

During each step t, the player (client) cⱼ selects a suitable bitrate level rₜ₊₁ for the next segments to be downloaded using the rate adaptation (ABR) algorithm. The selected bitrate may adapt to the available throughput wₜ from all the available servers, and maintain the buffer Bₜ occupancy within a safe region (i.e., between underflow and overflow thresholds). The levels of bitrate and resolutions listed in the MPD file can be represented as:

$$\{ \begin{matrix}{R}_{v} = \{ {r}_{1} … {r}_{i} … {r}_{Z} \} , \\ {L}_{v} = \{ {l}_{1} … {l}_{i} … {l}_{Z} \} ,\end{matrix} \qquad ( 1 )$$

where rϵ[r¹ . . . r^{η}] and lϵ[l¹ . . . l^{η}] with η being the total number of available bitrate and resolution levels. Having the content resolution, each client 100 chooses a suitable level of bitrate and resolution which is in the range of its device display resolution.

Embodiments of the present disclosure aim to eliminate buffer underrun and overflow issues. Measurement of the playback buffer occupancy may be performed as follows:

$${B}_{i} = Max ( ( {B}_{i - 1} - \frac{Size ( {seg}_{i} , {r}_{i} , {l}_{i} )}{{w}_{i}} ) + I , 0 ) , \qquad ( 2 )$$

where Bₜ₋₁ is the buffer occupancy estimate in the previous step t−1, Size(segₜ, rₜ, lₜ) is the size of the segment t which is encoded at bitrate rₜ and resolution lₜ, and I is the increase in the buffer occupancy when segₜ is fully downloaded and the decrease during the video rendering. Other methods of estimating buffer occupancy are also possible.

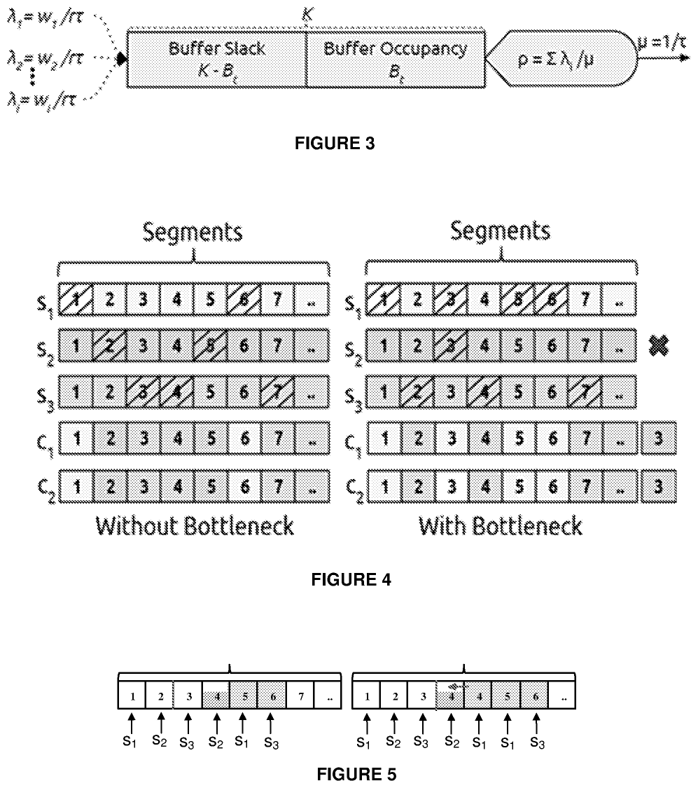

The arrival of video segments at client 100 may be modelled as a finite buffer, batch-arrival, M^{x}/D/1/K queue, for example, where K is the buffer capacity. An example queueing model for the client 100 is illustrated in FIG. 3. The model may establish a relationship between download throughput, available bitrates, buffer capacity and expected buffer occupancy, thereby allowing client 100 to adapt the video bitrate to estimated throughput while keeping the buffer occupancy at half the buffer capacity at steady state.

As illustrated in FIG. 3, the arrival of segments from different servers is modelled as a batch process, and the total effective arrival rate is calculated by summing the individual arrival rates λᵢ from respective servers sᵢ. Each segment has a duration of τ seconds. Every second, a single decoder in the client 100 services a segment at the rate μ=1/τ segment/second. Let the download throughput from server sᵢ be wᵢ bps downloading the segment of quality rᵢ bps. Therefore, segments are arriving at the queue with the rate of

$$\frac{{w}_{i}}{{r}_{i} \times τ}$$

segments per second and get stored in the queue with a capacity of K seconds. To limit the number of bitrate switches, segments in the same batch may be downloaded at the same quality. Thus, the arrival rate from server sᵢ is

$${λ}_{i} = \frac{{w}_{i}}{r τ} .$$

The total arrival rate at the queue is the sum of all the arrival rates in the batch, i.e., λ=Σᵢλᵢ. Thus, the queue server utilization is ρ=Σᵢλᵢ/μ=w/r, where w=Σᵢ wᵢ. The expected average queue length O_{k,ρ} and expected buffer slack Bs_{K,r,w}=K−O_{k,ρ} may be computed using the analytical solution given by Brun and Garcia (J. Appl. Prob. (2000), 1092-1098).

The rate adaptation algorithm of certain embodiments considers the aggregate arrival rate from different servers. Let a given video be encoded with bitrate values R={r¹, r², . . . , r^{η}}, with r^{j}<r^{k} if j<k. The algorithm selects the bitrate r at time t such that the expected buffer slack Bs is closest to the estimated (or otherwise obtained) buffer occupancy Bₜ,

$$r = arg {min}_{{r}^{i} ∈ R} \vert {Bs}_{K , {r}^{i} , w} - {B}_{t} \vert , \qquad ( 3 )$$

breaking ties by favoring the higher bitrate. Unlike previously known approaches, Bs is a function of the estimated aggregate throughput from the different servers other than current bitrate and total buffer capacity (or size).

Because client 100 concurrently downloads segments from more than one server, the download scheduler 240 may keep track of current buffer levels before sending a segment request, to avoid exceeding the buffer capacity. For example, a client 100 with 30 seconds of buffer capacity and with a current buffer occupancy of 24 seconds playing a video with 4 seconds segment duration and five available servers can send a request to only one server. If the current buffer occupancy drops below 10 seconds, the download scheduler 240 is expected to send a segment request to all the servers sᵢ. The download scheduler 240 according to certain embodiments may check for the last throughput from the servers sᵢ. In a batch, the download scheduler 240 may request segments that are needed earlier for playback from servers with higher throughput values, for example as shown in Algorithm 1 below.

Algorithm 1: Next segment download strategy in a batch.

Bₜ: Playback buffer occupancy; τ: Segment duration;
K: Buffer capacity;
M: Total number of available servers;
Servers {s₁, s₂,. . .,s_{M}} ∈ S are sorted based on their last throughput;
while i ≤ M do

| | |
|---|---|
| \| | if Bₜ + τ ≤ K and sᵢ is not downloading then |
| \| | \| Download next segment from sᵢ; |
| \| | |

end

end

Certain embodiments may employ a bottleneck detection strategy to improve performance. Since the download scheduler 240 preferably does not request the same segment from more than one server to avoid wastage of resources, a bottleneck server can hamper the playback quality of experience (QoE) by causing stalls. To avoid this situation, the client 100 can identify the bottleneck server and refrain from requesting a new segment from it.

The download scheduler 240 may consider a server as a bottleneck server if the download throughput of the last segment is less than the lowest available bitrate. The scheduler 240 may request a redundant segment from a bottleneck server that is already being downloaded by another server to keep track of the current state of it. Once the throughput of the bottleneck server increases beyond the lowest available bitrate, the scheduler 240 may continue downloading the next non-redundant segment from it. As described earlier, a segment may be requested from a server only if there is no other segment download in progress. This avoids choking an already overloaded server as well as downloading too many redundant segments, and also avoids throughput overestimation.

To implement a bottleneck detection strategy, the download scheduler 240 may be given the additional responsibility of maintaining the time-line of downloads. An example of this situation is explained with reference to FIG. 4. In a case without bottlenecks, the clients c₁ and c₂ fetch the segments in parallel and they come without redundancy from servers in the order s₁, s₂, s₃, s₂, s₁, s₃, respectively. In the presence of a bottleneck (server s₂), both clients detect the server bottleneck during the downloading process and react quickly by re-requesting seg₃ from s₁ with fast throughput. This leads to download of a redundant segment from the bottleneck server to keep track of its status.

Embodiments may implement a scheduling policy, by scheduler 240 for example, as follows. The different network conditions in the download path cause variance in the associated throughput. Although the imminently required segments are downloaded from the server with the highest throughput in a greedy fashion, they may arrive out of order due to dynamic network conditions and server loads. The client 100 should not skip a segment, so the unavailability of the next segment for playback causes stalls even though subsequent segments are available. For example, in FIG. 5, it can be seen that sego is unavailable, but segments seg₅ and seg₆ are present in the buffer. When the client 100 completes the playback of seg₃, it will stall until sego arrives as the effective buffer occupancy is now zero. To avoid such situations, the scheduler 240 of client 100 can re-request sego from another server. The re-requesting of a segment is preferably not too frequent as it may cause a high number of redundant segment requests. On the other hand, too few re-requests may lead to a stall. In certain embodiments, the scheduler 240 aborts the ongoing request and re-requests the missing segment when the contiguous part of the buffer drops below 12 seconds.

### Client Device 104

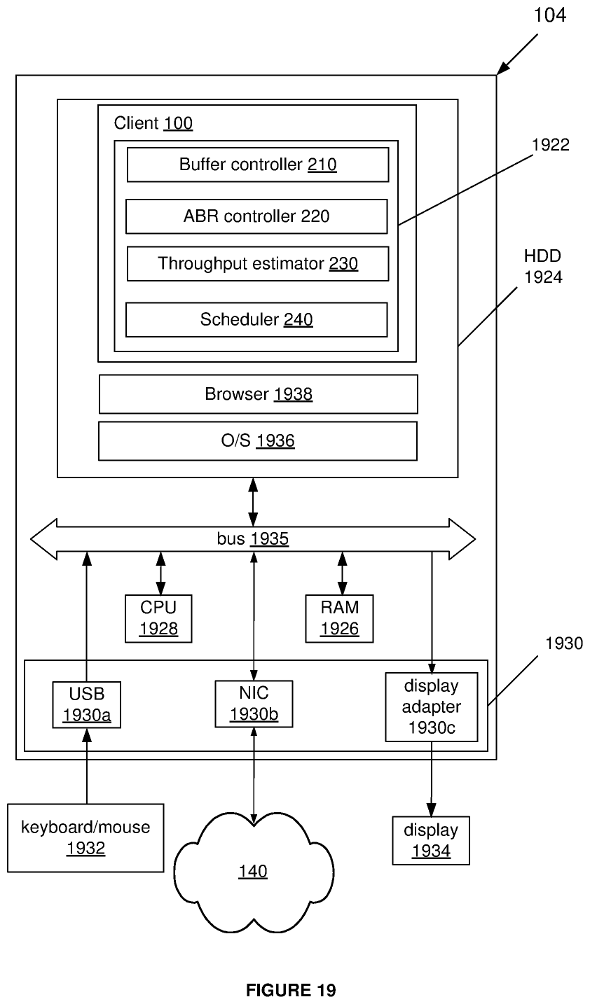

An example architecture of a client device 104 is shown in FIG. 19. As mentioned above, the client device 104 is able to communicate with other components of the system 50, including the servers sᵢ, over network 140 using standard communication protocols.

The components of the client device 104 can be configured in a variety of ways. The components can be implemented entirely by software to be executed on standard computer server hardware, which may comprise one hardware unit or different computer hardware units distributed over various locations, some of which may require the communications network 140 for communication. A number of the components or parts thereof may also be implemented by application specific integrated circuits (ASICs) or field programmable gate arrays.

In the example shown in FIG. 19, the client device 104 may be a commercially available server computer system based on a 32 bit or a 64 bit Intel architecture, and the processes and/or methods executed or performed by the client device 104 are implemented in the form of programming instructions of one or more software components or modules 1922 stored on non-volatile (e.g., hard disk) computer-readable storage 1924 associated with the client device 104. At least parts of the software modules 1922 could alternatively be implemented as one or more dedicated hardware components, such as application-specific integrated circuits (ASICs) and/or field programmable gate arrays (FPGAs).

The client device 104 includes at least one or more of the following standard, commercially available, computer components, all interconnected by a bus 1935:

(a) random access memory (RAM) 1926;
(b) at least one computer processor 1928, and
(c) external computer interfaces 1930:
(i) universal serial bus (USB) interfaces 1930a (at least one of which is connected to one or more user-interface devices, such as a keyboard, a pointing device (e.g., a mouse 1932 or touchpad),
(ii) a network interface connector (NIC) 1930b which connects the computer system 104 to a data communications network, such as the Internet 140; and
(iii) a display adapter 1930c, which is connected to a display device 1934 such as a liquid-crystal display (LCD) panel device.

The client device 104 includes a plurality of standard software modules, including an operating system (OS) 1936 (e.g., Linux or Microsoft Windows), a browser 1938, and standard libraries such as a Javascript library (not shown). Operating system 1936 may include standard components for causing graphics to be rendered to display 1934, in accordance with data received by client application 100 from the download servers sᵢ, for example.

The boundaries between the modules and components in the software modules 1922 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the client device 104 may be executed by a module (of software modules 1922) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The client device 104 normally processes information according to a program (a list of internally stored instructions such as a particular application program and/or an operating system) and produces resultant output information via input/output (I/O) devices 1930. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

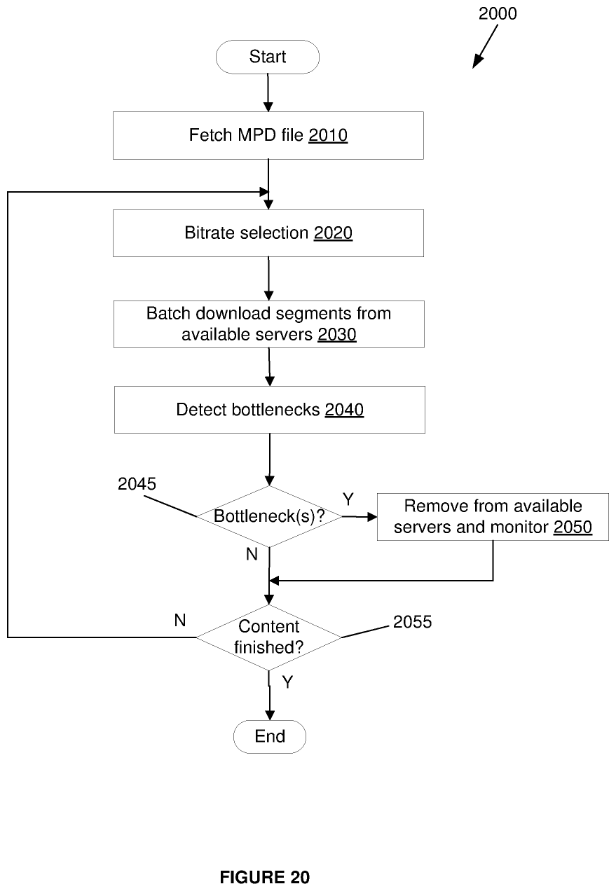

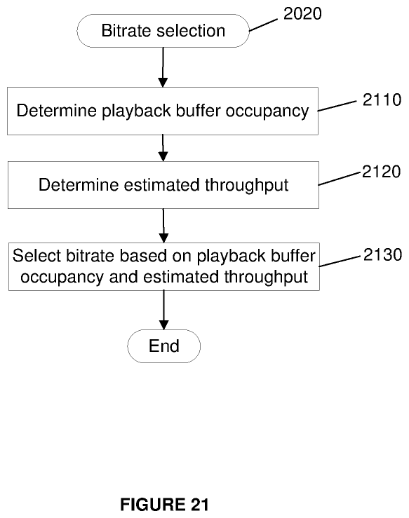

Flow diagrams depicting certain processes according to embodiments of the disclosure are shown in FIGS. 20 and 21.

Referring to FIG. 20, a streaming process 2000 implemented at client device 104 begins at step 2010 by client application 100 of the client device 104 fetching an MPD file, via scheduler 240 for example. Process 2000 is iterative, and continues until the entire desired content has been delivered to client 100.

An address of the MPD file may be stored in a webpage at which a user using a web browser of client device 104 desires to play content. The MPD file may be stored at, and retrieved from, any one of the available servers sᵢ, for example. In some embodiments, the MPD file is stored at a server which is different than the server sᵢ that stores the content. The MPD file contains information about the segments in the content to be streamed.

At step 2020, the ABR controller 220 of client 100 selects a bitrate for the current batch of segments to be downloaded. For the first iteration, a default bitrate may be used as the starting bitrate. Advantageously, in some embodiments, the lowest available bitrate may be selected as the starting bitrate, to enable fast download and low startup delay. For subsequent iterations, the bitrate may be determined according to a rate adaptation algorithm as described above. Client 100 may also determine an available resolution according to the capability of display adapter 1930c of client device 104, for example. ABR controller 220 passes the selected bitrate and, if applicable, the available resolution to scheduler 240.

At step 2030, scheduler 240 downloads segments from at least a subset of the available servers at the selected bitrate. The download scheduler 240 may request segments that are needed earlier for playback from servers with higher throughput values, for example as shown in Algorithm 1 and as described above.

At step 2040, the download scheduler 240 may detect, based on the segments downloaded at step 2030, whether any servers are bottleneck servers. If one or more bottlenecks are detected (block 2045), download scheduler 240 may remove them from the list of available servers, and begin monitoring any such bottleneck servers, at 2050. Monitoring may continue in parallel to iterations of batch segment downloads (not shown). If any bottleneck servers become available again during the course of monitoring, they may be restored to the list of available servers for subsequent iterations.

If no bottlenecks are detected, then at 2055, the client 100 (for example, via download scheduler 240) checks whether streaming of the content is complete. For example, the download scheduler 240 may check whether a segment number matches a last segment number in the MPD file. If the content has not been fully streamed, the process 2000 returns to bitrate selection at 2020. Otherwise, the process 2000 ends.

Turning to FIG. 21, a bitrate selection process 2020 of process 2000 includes an operation 2110 of determining, e.g. by buffer controller 210 and/or ABR controller 220, a playback buffer occupancy of the client device 100.

At operation 2120, throughput estimator 230 determines an estimated throughput based on one or more of the segments downloaded by scheduler 240, and this is received by the ABR controller 220.

At operation 2130, the ABR controller 220 receives the buffer occupancy and estimated throughput, and determines a bitrate that can optimise the quality of experience of client device 104, for example by selecting a bitrate such that the expected buffer slack Bs is closest to the estimated (or otherwise obtained) buffer occupancy Bₜ, where Bₜ depends on the aggregate throughput from the different servers.

Experimental Evaluation

A client 100 configured in accordance with certain embodiments was tested to evaluate its performance with respect to known client configurations. In the following discussion, the client is referred to as MSDASH.

A. Methodology

Network Profiles: To extensively test MSDASH, five different server profiles were adopted. The parameters of the server profiles are shown in Table II. As can be seen from Table II, each server profile includes a throughput value that varies over time in a way which differs from server to server. The different profiles P1 to P5 emulate a heterogeneous workload on the respective servers. P1 and P4 follow an up-down-up pattern, whereas P2 and P5 follow a down-up-down pattern. These profiles are adopted from the DASH Industry (DASH-IF) Forum Guidelines. One of the servers is configured as a bottleneck server, corresponding to profile P3. The inter-variation duration in Table II is the duration of each different throughput value over the streaming session time.

TABLE II
Characteristics of Network Profiles.

| Network | Throughput Values | Inter-variation |
|---|---|---|
| Profile | (Mbps) | Duration (s) |
| P1 | 4, 3.5, 3, 2.5, 3, 3.5 | 30 |
| P2 | 2.5, 3, 3.5, 4, 3.5, 3 | 30 |
| P3 | 5, 0.25 | 180 |
| P4 | 9, 4, 3.5, 3, 3.5, 4, 9, 4 | 30 |
| P5 | 3, 3.5, 4, 9, 4, 3.5, 3, 3.5 | 30 |

Video Parameters: The reference video sample Big Buck Bunny (BBB) from the DASH dataset was used for testing purposes. It is encoded with the H.264/MPEG-4 codec at nine bitrate levels R={4.2, 3.5, 3, 2.5, 2, 1.5, 1, 0.75, 0.35} Mbps, content resolutions L={240, 360, 480, 720, 1080, 1920}p and comprises approximately T=600 s of total video duration. These bitrate level and resolution values correspond to quality levels that are used in YouTube. Testing was performed on 1 s, 2 s and 4 s segments for 30 s, 60 s, and 120 s buffer capacities (or sizes).

Comparison Schemes: To evaluate performance, MSDASH was compared against four CDN-based load balancing rule schemes which are implemented in the web server NGINX and can be summarised as follows: (a) Round Robin: The set of requests to the DASH servers are distributed based on a round robin mechanism. (b) Least Connected: The next requests are assigned to the DASH servers with low load. Thus, this scheme tries not to overload a busy server with many requests. (c) Session Persistence: this scheme always directs the request from the same client to the same DASH server except when this server is down. To achieve this, it uses a hash function to determine which server to select for next request. (d) Weighted: this scheme assigns a weight for each DASH server, and this weight is used in the load balancer decision. For example, if weight equals three for a server, then the load balancer will direct three requests to this server.

Experimental Setup: A set of realistic trace-driven on-demand (VoD) video streaming experiments was performed using different real-world network profiles (i.e., throughput variability) from the DASH-IF Guidelines, segment durations (i.e., 1 s, 2 s, and 4 s), QoE metrics (i.e., average bitrate, bitrate switch, startup delay, and stalls), number of DASH clients and DASH servers. The experimental setup included seven machines running Ubuntu 16.04 LTS for DASH clients, DASH servers, and logging. One machine was a server station with 30 GB RAM, Core i7 CPU and two GPUs GeForce GTX 295. The server station ran five Virtual Box VMs, each VM representing a DASH server which hosts the video and runs a simple Apache HTTP server (v2.4). Five machines with 4 GB RAM and Core i7 CPUs act as DASH clients, each machine running the Google Chrome browser to host a modified dash.js based player (the MSDASH player shown in FIG. 2). All machines were connected via a D-link Gigabit switch, and the tc-NetEm network emulator was used, in particular the Hierarchical Token Bucket (HTB) together with Stochastic Fairness Queuing (SFQ) queues to shape the total capacity of the links between DASH clients and servers according to the above network profiles. MSDASH considers the aggregate bandwidth of the last measured throughput from all the servers. The maximum playback buffer capacity (K) was set as 30 s, 60 s, and 120 s for 1 s, 2 s and 4 s segment duration, respectively. The underflow prevention threshold was set as 8 s.

B. Implementation

The proposed method was implemented as a modification to dash.js v2.6.6. In particular, modifications were made to XMLHttpRequest, BaseURLSelector and how the segments will be scheduled in SchedulerController, in order to make use of multiple download sources. The rate adaptation algorithm described above was also added as Rule in the ABRController.

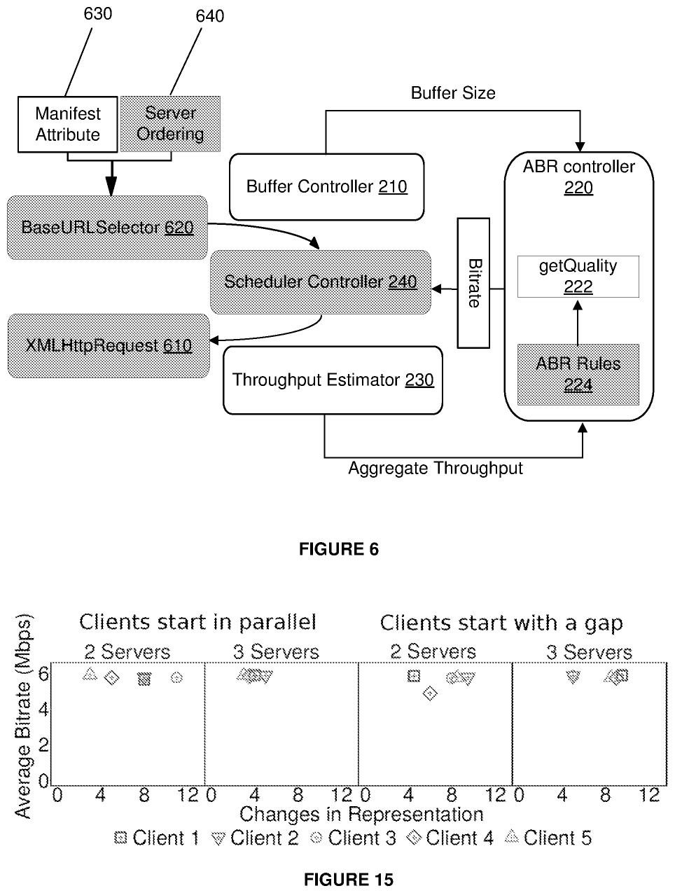

In particular, with reference to FIG. 6, the following functionality was added to the DASH reference player dash.js:
(a) SchedulerController 240: Controls and generates multiple requests at a time based on the bitrate selected by the rate adaptation algorithm and the next available server given by the BaseURLSelector 620. Then, it places the request in the XMLHttpRequest 610 for requesting the segment from the corresponding server.
(b) BaseURLSelector 620: Gets the URLs of the existing servers from the Manifest attribute 630, sorted by their last throughput to decide the next server for downloading the segment.
(c) XMLHttpRequest 610: Prepares the requests given by the SchedulerController 240 in a proper xhr format through addHttpRequest and modifyRequestHeader methods. Then, it sends multiple requests to different DASH servers in parallel via HTTP GET (i.e., xhr.send( )), and receives the responses of the corresponding segments.
(d) ABRController 220: Implements a set of bitrate decision rules to select the suitable bitrate for next parallel segments to be downloaded respecting the buffer occupancy and aggregate throughput given by BufferController 210 and Throughput Estimator 230, respectively. The ABR Rules 224 implement the rate adaptation algorithm described above and are responsible for performing ABR decisions based on the throughput from a server. Then, it passes such bitrate decisions to the SchedulerController 240, and a sorted order of servers to BaseURLSelector 620. The ABR Controller 220 may include a getQuality function 222 that is used to determine the bitrate (e.g., via Equation (3)).

Performance Metrics: To evaluate performance, the following QoE metrics were used. The overall quality was measured using the average bitrate played by a DASH client. The number of changes in representations, and their magnitudes, were also counted. The playback stall durations and the number of occurrences of a stall were measured. The overall effect of the performance metrics on QoE can be summarised by the following model:

$$QoE = {\sum }_{i = 1}^{Z} f ( {R}_{i} ) - λ {\sum }_{i = 1}^{Z - 1} \vert f ( {R}_{i + 1} ) - f ( {R}_{i} ) \vert - α {T}_{stall} - {α}_{s} {T}_{s} \qquad ( 4 )$$

Here, the QoE for the Z segments played by a DASH client is a function of their aggregate bitrate f(Rₜ), and the magnitude of the difference in adjacently played segments f(Rₜ₊₁)−f(Rₜ), start-up delay Tₛ and total playback stalls Tₛₜₐₗₗ. f is the identity function, λ=1, α and αₛ are the maximum representation bitrate.

C. Results and Analysis

The experimental results described below comprise a set of trace-driven and real-world test cases. The test cases are divided into five scenarios as shown below. The experimental results show that MSDASH can significantly improve the viewer QoE and deliver a high quality video in all considered scenarios.

Scenario 1 (Single Server DASH vs MSDASH): In the first test, one client requests video segment from a single server for five different network profiles P1 to P5. This is compared to the case where five different clients are requesting video segments from all the five servers s₁ to s₅ with respective network profiles P1 to P5. The idea is to compare the performance of a one-to-one client-server relationship for five clients with the performance when all clients use all servers using the proposed MSDASH solution.

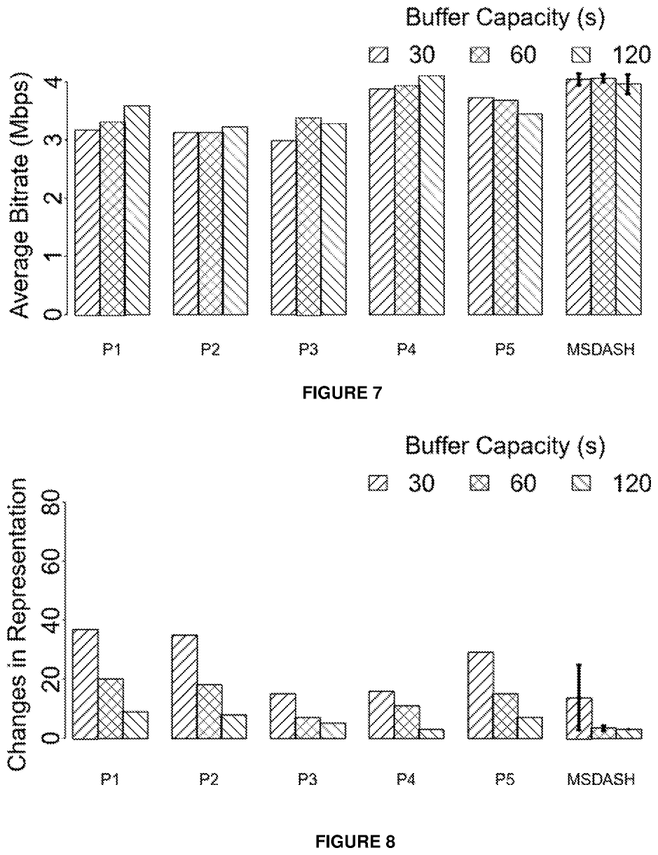

FIG. 7 shows the average bitrate played during the entire session. Clients experience an average bitrate of 2.9 Mbps to 4 Mbps under profile P1 to P5 with different buffer sizes when one client is requesting video segments from only one server. Performance under profile P4 is better than all other profiles as it has the highest magnitude of throughput and starts with the highest value. The client connecting to the server with profile P4 experiences average bitrate 3.8, 3.9, and 4.1 Mbs for the buffer size 30 s, 60 s, and 120 s, respectively. However, with MSDASH where all clients are sharing five servers with these five different network profiles, the clients experience average bitrates of 4.0, 4.0, 3.9 Mbps on average for the buffer sizes 30 s, 60 s, and 120 s, respectively.

Similarly, under a one-to-one client-server architecture, as shown in FIG. 8, the number of changes in representation varies from 3 to 37 for different buffer capacities. For profile P3 the client experiences the least number of changes in representation for the 30 s and 60 s buffer, i.e., 15 and 7. For a 120 s buffer capacity, the least number of changes in representation is 3 for P4. MSDASH outperforms all of them—all 5 clients experience, on average, 13.8, 3.4, and 3 changes in representation for the respective buffer capacities (30 s, 60 s, and 120 s).

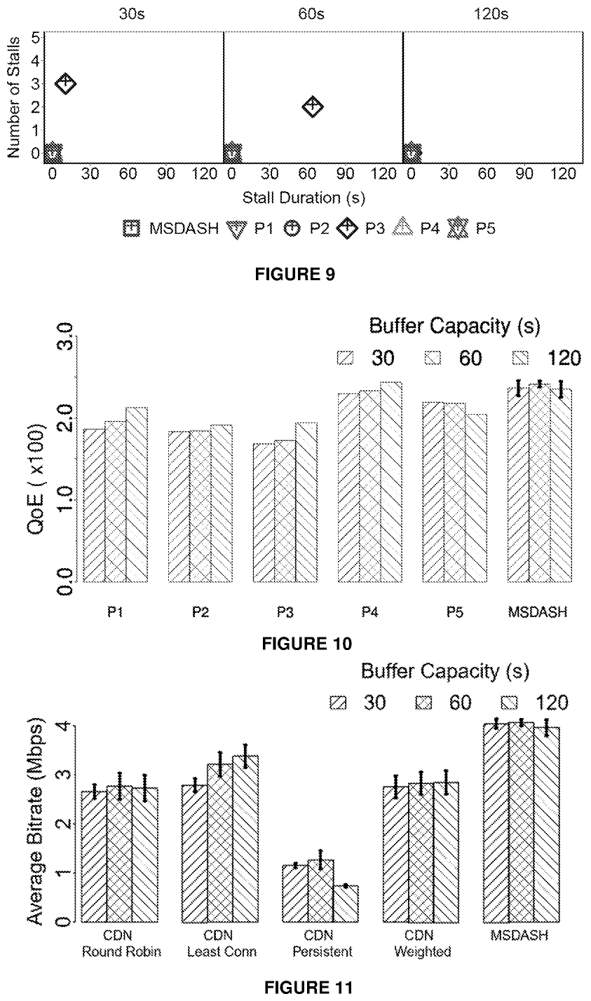

MSDASH also performs better, with no stalls, even though the server with profile P3 has a bottleneck. As shown in FIG. 9, the client that only requests from the server with profile P3 experiences 10 s and 64 s stalls for the 30 s and 60 s buffer capacity, and stalls twice and three times, respectively.

The small error bar in FIG. 7 shows that MSDASH is very fair amongst the clients regarding average bitrate played. Although the error bar for the number of changes in representation for a 30 s buffer capacity is comparatively bigger for MSDASH, the average number of representation changes is still less than that for the clients in the one-to-one client-server architecture, as can be seen in FIG. 8.

A QoE score as discussed above was computed for the clients in the one-to-one server architecture, connecting to servers with profile P1 to P5, and for the clients running MSDASH. The results are shown in FIG. 10. It can be seen that clients with MSDASH have a QoE score of 2.35 to 2.41 (×100). MSDASH is at least 3%, and up to 40%, better than in the one-to-one client-server architecture for a buffer capacity of 30 s, and at least 3.4%, and up to 40% better than in the one-to-one client-server architecture for a buffer capacity of 60 s. For a 120 s buffer capacity, the QoE is comparable to the nearest value for P4 and 23% better than the smallest value for P2.

Scenario 2 (CDN-based Load Balancing Rules vs MSDASH): To check the robustness of MSDASH in real-world network environments, MSDASH was compared with CDN-based load balancing rule schemes that are presently implemented. Five servers with five different network profiles (P1 to P5) were run, and were shared by five concurrent clients. Each profile was used to throttle the total capacity between a DASH server and the set of clients.

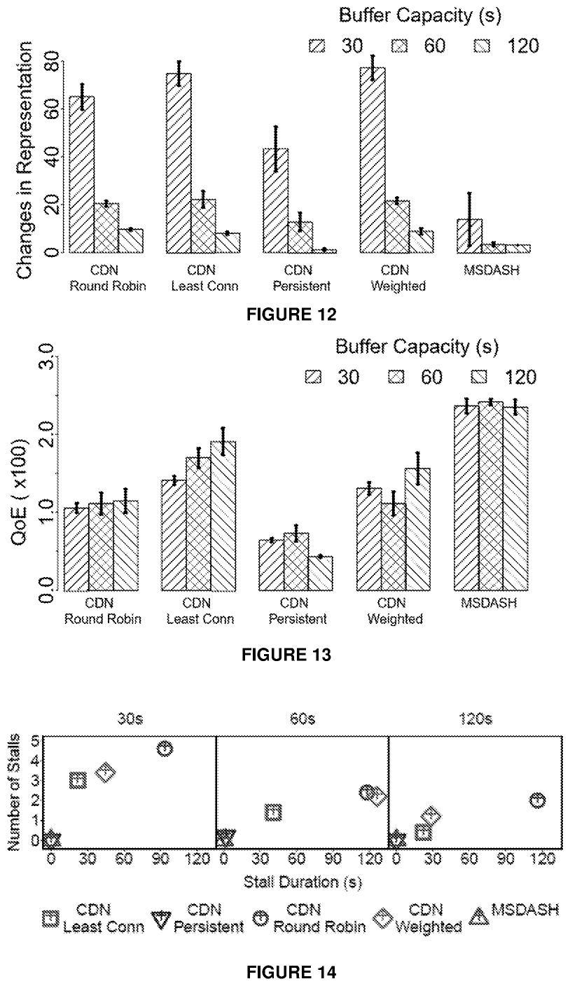

FIG. 11 depicts the average bitrate played during the video streaming session of 596 s. In all buffer size configurations, it can be seen that MSDASH achieves the best and the most stable average bitrate, ranging from 3.7 Mbps to 4 Mbps (3.9 Mbps as an average for all buffer capacity configurations) for all five clients compared to other CDN-based load balancing rules schemes, with the fewest changes in representation, as shown in FIG. 12. Also, MSDASH ensures the fairest distribution of the average bitrate among all clients with a variation of 0.2 Mbps, 0.15 Mbps, and 0.3 Mbps, for 30 s, 60 s, and 120 s, respectively. Moreover, two important observations are that (i) the CDN least connected scheme achieves the second best result in average bitrate after MSDASH, and (ii) the CDN persistent scheme gets the worst results compared to others. This is because the CDN least connected scheme applies an efficient request strategy that distributes the DASH client requests across DASH servers according to their capacities. This strategy sends the requests to a powerful server which executes requests more quickly, and alleviates the negative effects of the bottleneck server. However, the CDN persistent scheme creates a fixed association (hash value) between a client and a server, where all the requests from a given hash value are always forwarded to the same server. Thus, a client attached to a bottleneck server will always receive a low bitrate, and this affects the average results over all clients. MSDASH, in contrast to CDN-based load balancing rules, leverages all existing DASH servers and downloads from all of them in parallel. It successfully detects the bottleneck server via a smart bottleneck detection strategy (see above), and thus it avoids requesting from this server.

Similarly, in all buffer capacity configurations, MSDASH achieves the best average QoE (computed using Eq. (4)) with zero stalls (and thus zero stall duration), very low average number of changes in representation and startup delay compared to CDN-based load balancing rule schemes as shown in FIGS. 12, 13, and 14. Clients in MSDASH experience a high QoE that ranges from 2.35 to 2.41 (×100) compared to the CDN least connected scheme that ranges from 1.4 to 1.9, the CDN persistent scheme that ranges from 0.43 to 0.73, the CDN round robin scheme that ranges from 1.05 to 1.14, and the CDN weighted scheme that ranges from 1.11 to 1.56, on average for all buffer capacity configurations. The average number of changes in representation, stalls and stall duration are high for the CDN-based rules except for the CDN persistent scheme that obtains zero stalls.

The CDN-based schemes experience a low average QoE. Of note, the CDN round robin scheme suffers from many stalls having long duration, because this scheme uses the round robin mechanism to distribute the requests. Thus, during the turn of the bottleneck server (which is inevitably downloaded from because of the round robin scheme), the segments take long times to be downloaded by the clients, leading to video stall.

Scenario 3 (Internet Dataset Test): The performance of MSDASH was investigated by performing a set of experiments over the real-world Internet. The Distributed DASH Dataset was used; it consists of data mirrored at three servers located in different geographical areas (France, Austria, and Italy). A 6 minute video encoded at 17 bitrate levels R={0.1, 0.15, 0.2, 0.25, 0.3, 0.4, 0.5, 0.7, 0.9, 1.2, 1.5, 2, 2.5, 3, 4, 5, 6} Mpbs was streamed with segment durations of 2 s and 4 s. Five clients were run in two test scenarios: (i) all of the clients start video sessions in parallel, and (ii) clients start incrementally after each other with a gap of Δt=60 seconds. FIG. 15 represents the average bitrate selected by MSDASH plotted against the number of bitrate changes for 2 s and 4 s segment durations running five clients in the two tests. It shows that most of the time the clients select the highest bitrate of 6 Mbps by downloading video segments in parallel from 2 or 3 servers. Also, the number of changes in representation is 5-10 in both tests. Two important observations can be drawn from this scenario. First, when the number of servers increases, the clients achieve better performance. The five clients that together leverage the three servers achieve approximately 10% improvement in the selected bitrate and require 25% fewer bitrate changes, compared to clients using two servers. Second, when the clients start and finish at different times then they obtain fairer bandwidth share compared with when they run together, and thus a better performance is achieved in the second test.

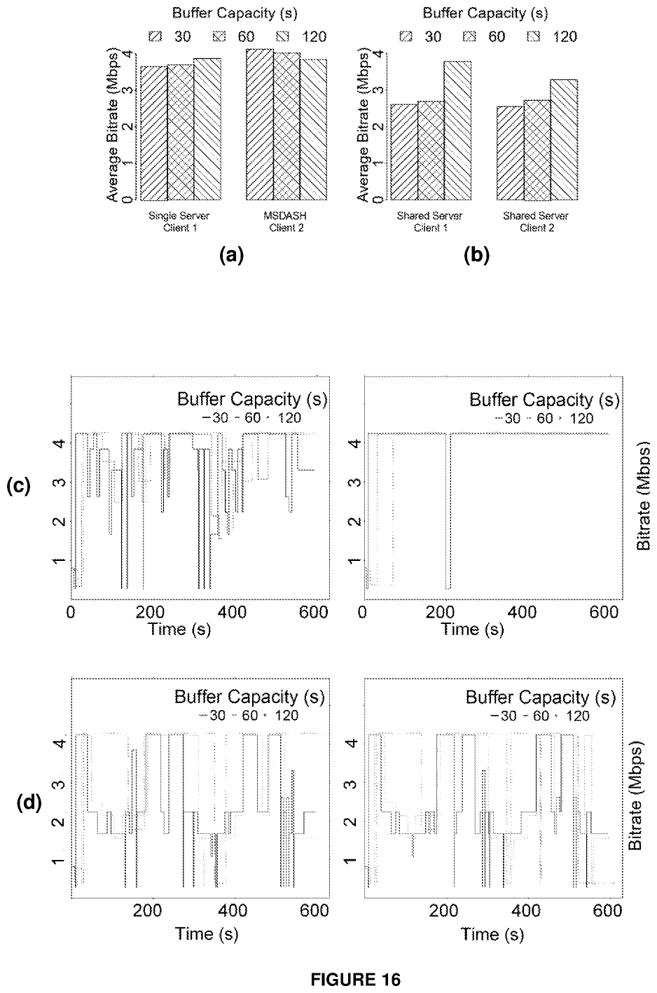

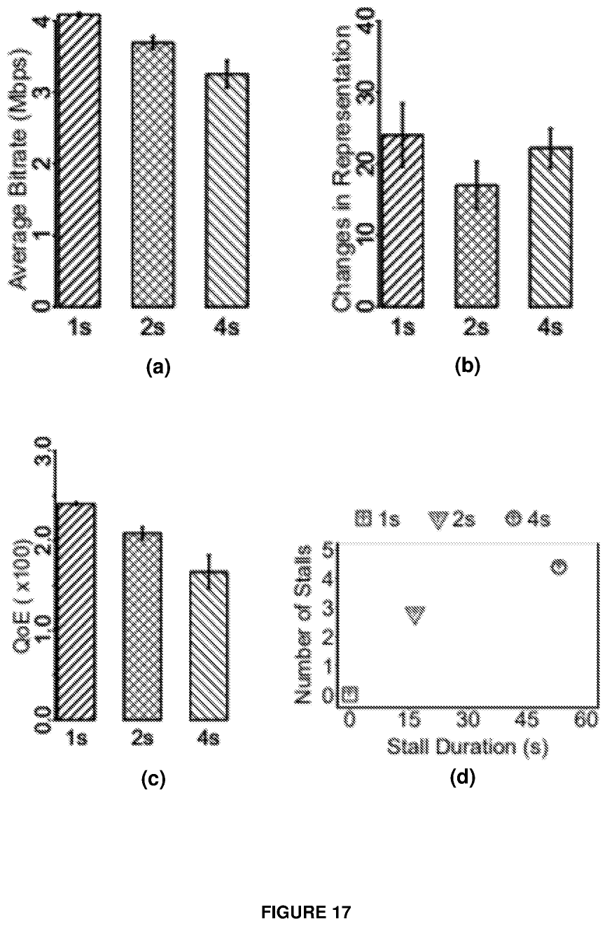

Scenario 4 (Fairness of MSDASH): To compare the fairness for an MSDASH client with a single-server client, two test cases were run as shown in FIG. 16: (a) running two clients simultaneously, one MSDASH client (sharing five servers with profile P1-P5) and one single DASH client (connected to the server with profile P4), (b) two single DASH clients sharing the server with profile P4. It can be seen that the MSDASH client is friendly when it runs with a single DASH client and it shares the available bandwidth equally with the single DASH client (TCP fair share). During the streaming session, the MSDASH client plays the video at the highest and most stable possible available bitrate (3.9-4.2 Mbps) with fewer changes in representation (5 changes as an average for all buffer capacity configurations) and without any stalls. This is because MSDASH benefits from all the existing servers, and thus the buffer occupancy of MSDASH frequently reaches the maximum capacity in all buffer configurations (switch to OFF state, see FIGS. 16(c) and 16(d)). This gives fairer shared bandwidth for the single DASH client to improve its bitrate selection (3.7-4 Mbps) as depicted in FIG. 16(a), compared to clients in FIG. 16(b) (2.7-4 Mbps).

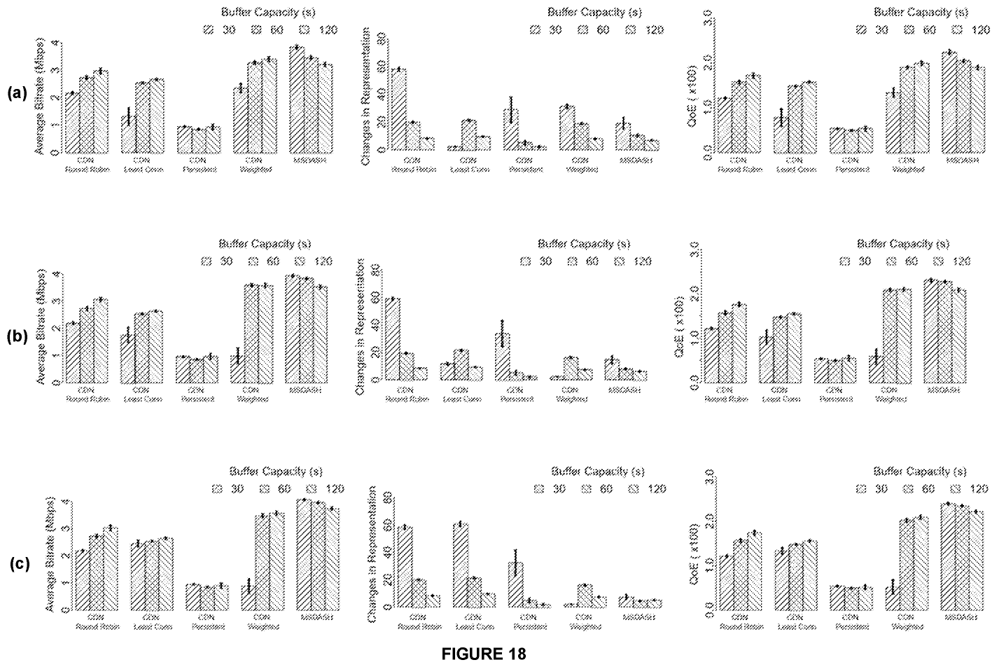

Scenario 5 (Large-scale Deployment of MSDASH): To evaluate the scalability of MSDASH, three real-world test case experiments were performed in the NCL testbed at https://ncl.sg. These experiments consisted of 100 clients (rendering video over Google Chrome), 4 DASH servers with different profiles, and various total last-mile bandwidths of the single bottleneck link. To emulate a real-world network environment, a realistic network topology provided by the NCL testbed was used, and the performance of MSDASH was compared to the CDN-based load balancing rule schemes (round robin, least connected, persistent connection, and weighted). The configuration of the test cases was defined as follows: (a) 100 clients sharing a bottleneck network with total bandwidth of 300 Mbps and four servers {s₁, . . . , s₄} with network profiles (60, 70, 80, and 90) Mbps (FIG. 18(a)), (b) 100 clients sharing a bottleneck network with total bandwidth of 350 Mbps and four servers {s₁, . . . , s₄} with network profiles (60, 70, 80, and 140)Mbps (FIG. 18(b)), (c) 100 clients sharing a bottleneck network with total bandwidth of 400 Mbps and four servers {s₁, . . . , s₄} with network profiles (60, 70, 80, and 190)Mbps (FIG. 18(c)). In the case of weighted load balancing rules, the four servers {s₁, . . . , s₄} are allocated with weight 1, 2, 3, and 4, respectively. The results show that for different buffer configurations, MSDASH clients select the best and most stable possible bitrate with high fairness (see the error bars in FIG. 18), the highest QoE, and fewest changes in representation. The weighted load balancing rule has comparable performance with respect to MSDASH for 120 s buffer capacity in terms of average bitrate because a higher weight was allocated to the server with the highest throughput. The changes in representation are also higher for weighted load balancing rules that cause a reduction in overall QoE. The small error bar for MSDASH indicates higher fairness for a large number of clients as well. The 100 clients start sequentially with a gap of 0.5 seconds between them (total gap of 50 seconds between first and last), so the average bitrate in a few cases for MSDASH and the weighted load balancing rule is slightly higher than the full capacity of 300 Mbps, 350 Mbps, and 400 Mbps for the three test cases.

Embodiments of the present disclosure have several advantages over prior art approaches with respect to robustness. For example, the present embodiments are highly fault tolerant. In a single server DASH delivery system as in the prior art, the critical failure mode is when the client can no longer communicate with the DASH server such as due to a server bottleneck, unreliable link, faulty server, or sudden fluctuation in the network condition. In this situation, CDN-based solutions might help, but they have been shown to introduce a delay (i.e., DNS redirection) which may harm the player buffer occupancy and affect the end-user QoE negatively. However, embodiments of the present disclosure address these issues by leveraging multiple servers and avoiding the affected link or server thanks to the robust and smart bottleneck detection strategy detailed above. If the client is unable to reach the server, it will automatically ignore downloading the next segments from it and use only the remaining servers. Moreover, the client periodically keeps tracks the status of the down servers by either trying to connect with them again, or downloading the already played segments if the server is considered as a bottleneck.

In some circumstances, such as when multiple clients start competing for the available bandwidth in a shared network environment (e.g., last mile network), a client-side bottleneck may occur. The performance of MSDASH and CDN-based load balancing rules was tested for the case of a last mile bottleneck where there is no traffic shaping at all five servers, but all five servers and clients share a common link of 15 Mbps. In this scenario, all five clients played the video at 3 Mbps on average for both MSDASH as well as for all CDN-based load balancing rules.

In the presence of a bottleneck server, a single server DASH client will suffer from stalls and frequent bitrate changes which results in a poor viewer QoE. In contrast, embodiments of the present disclosure use multiple servers and are able efficiently to detect a server bottleneck that may affect the viewer QoE based on a simple heuristic (e.g., embodiments may consider a server as a bottleneck if the download throughput is less than the lowest available bitrate), for example as discussed above.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method, performed at a client device, of streaming remotely located content, comprising:
communicating with a plurality of servers each of which hosts multiple copies of the content, said copies being encoded at different respective bitrates and each being divided into a plurality of segments that are arranged according to a time sequence; and
requesting a concurrent download of a set of segments from a group of download servers that is at least a subset of the plurality of servers,
wherein respective segments in the set are downloaded from different servers in the group of download servers, said segments being consecutive in the time sequence.

2. A method according to claim 1, further comprising monitoring a playback buffer occupancy of the client device.

3. A method according to claim 2, further comprising selecting a bitrate at which to download segments, based on the playback buffer occupancy of the client device and/or estimated throughput of the group of download servers.

4. A method according to claim 1, further comprising:
identifying one or more bottleneck servers of the plurality of servers; and
temporarily removing the one or more bottleneck servers from the group of download servers.

5. A method according to claim 4, further comprising:
monitoring a throughput status of the one or more bottleneck servers by requesting, from the one or more bottleneck servers, download of a segment that is already being downloaded from a server in the group of download servers.

6. A method according to claim 5, further comprising, responsive to the throughput status of a bottleneck server exceeding a bitrate threshold, restoring the bottleneck server to the group of download servers.

7. A method according to claim 1, wherein the servers are DASH servers.

8. A client device for streaming remotely located content, comprising:
at least one processor in communication with computer-readable storage having stored thereon instructions which, when executed by the at least one processor, cause the client device to:
communicate with a plurality of servers each of which hosts multiple copies of the content, said copies being encoded at different respective bitrates and each being divided into a plurality of segments that are arranged according to a time sequence; and
request a concurrent download of a set of segments from a group of download servers that is at least a subset of the plurality of servers,
wherein respective segments in the set are downloaded from different servers in the group of download servers, said segments being consecutive in the time sequence.

9. A client device according to claim 8, wherein the instructions further comprise instructions which, when executed by the at least one processor, cause the client device to monitor a playback buffer occupancy of the client device.

10. A client device according to claim 9, wherein the instructions further comprise instructions which, when executed by the at least one processor, cause the client device to select a bitrate at which to download segments, based on a playback buffer occupancy of the client device and/or estimated throughput of the group of download servers.

11. A client device according to claim 8, wherein the instructions further comprise instructions which, when executed by the at least one processor, cause the client device to:
identify one or more bottleneck servers of the plurality of servers; and
temporarily remove the one or more bottleneck servers from the group of download servers.

12. A client device according to claim 11, wherein the instructions further comprise instructions which, when executed by the at least one processor, cause the client device to:
monitor a throughput status of the one or more bottleneck servers by requesting, from the one or more bottleneck servers, download of a segment that is already being downloaded from a server in the group of download servers.

13. A client device according to claim 12, wherein the instructions further comprise instructions which, when executed by the at least one processor, cause the client device to, responsive to the throughput status of a bottleneck server exceeding a bitrate threshold, restore the bottleneck server to the group of download servers.

14. A client device according to claim 8, configured to communicate with servers that are DASH servers.

15. A non-volatile computer-readable storage medium having instructions stored thereon that, when executed by at least one processor of a client device, cause the client device to perform a method according to claim 1.

16. A computing device for streaming remotely located content from a plurality of servers each of which hosts multiple copies of the content, said copies being encoded at different respective bitrates and each being divided into a plurality of segments that are arranged according to a time sequence, the client device comprising:
a download scheduler that is configured to request a concurrent download of a set of segments from a group of download servers that is at least a subset of the plurality of servers,
wherein the download scheduler is configured to download respective segments in the set from different servers in the group of download servers, said segments being consecutive in the time sequence.

17. A computing device according to claim 16, further comprising a buffer controller that is configured to monitor a playback buffer occupancy of the computing device.

18. A computing device according to claim 17, further comprising an adaptive bitrate controller that is configured to:
communicate with the buffer controller to receive the playback buffer occupancy; and
select a bitrate at which to download segments, based on the playback buffer occupancy of the computing device and/or estimated throughput of the group of download servers.

19. A computing device according to claim 18, comprising a throughput estimator for determining estimated throughput of the group of download servers.

20. A computing device according to claim 16, wherein the download scheduler is configured to:
identify one or more bottleneck servers of the plurality of servers; and
temporarily remove the one or more bottleneck servers from the group of download servers.

21. A computing device according to claim 20, wherein the download scheduler is configured to:
monitor a throughput status of the one or more bottleneck servers by requesting, from the one or more bottleneck servers, download of a segment that is already being downloaded from a server in the group of download servers.

22. A computing device according to claim 21, wherein the download scheduler is configured to, responsive to the throughput status of a bottleneck server exceeding a bitrate threshold, restore the bottleneck server to the group of download servers.
